(19) United States
(12) Patent Application Publication
(10) Pub. No.: US 2012/0128389 A1
(43) Pub. Date: May 24, 2012

(54) CORONA DISCHARGER AND IMAGE FORMING APPARATUS

(75) Inventor: Hiroshi SAITO, Toride-shi (JP)

(73) Assignee: CANON KABUSHIKI KAISHA, Tokyo (JP)

(21) Appl. No.: 13/297,573

(22) Filed: Nov. 16, 2011

(30) Foreign Application Priority Data
Nov. 19, 2010 (JP) 2010-259017

(51) Int. Cl. G03G 15/02

(52) U.S. Cl. 399/170

(57) ABSTRACT

A corona discharger, including a shield for generating corona discharge by applying a voltage to a charging wire, the corona discharger includes a moving portion for moving the charging wire along a stretching direction; a stretching portion for stretching the charging wire through a first charging area, a non-charging area and a second charging area and for folding the charging wire in the non-charging area back into the second charging area, the first and second charging areas being substantially parallel with each other, and a portion of the charging wire disposed in the non-charging area having a length not less than a length of the charging wire disposed in the second charging area; and a controller for controlling the moving portion such that the portion of the charging wire disposed in the non-charging area replaces the portion of said charging wire disposed in the second charging area.

### FIELD OF THE INVENTION AND RELATED ART

The present invention relates to a corona discharger for generating corona discharge by applying a voltage to a charging wire and relates to an image forming apparatus using such a corona discharger.

An image forming apparatus in which a step of electrostatically transferring a toner image, electrostatically formed on a surface of an image bearing member, from the image bearing member onto a recording material such as paper is performed has been conventionally known. In such an image forming apparatus the surface of the image bearing member is uniformly charged, and an electrostatic latent image is formed on the charged surface and then is developed into the toner image with a toner. The toner image formed on the image bearing member is transferred onto the recording material under voltage application. The corona discharger is used as a charging means for charging such an image bearing member, a transfer means for transferring the toner image onto the recording material or a separating means for separating the recording material from the image bearing member.

The corona discharger generates the corona discharge by applying the voltage to the charging wire stretched in a shield. The charging wire used in such a corona discharger is determined by deposition or erosion of an electric discharge product by the electric discharge for a long time, thus being less liable to cause the electric discharge. As a result, for example, in the case where the surface of the image bearing member is electrically charged, charging non-uniformity occurs. In order to prevent the occurrence of the charging non-uniformity, a corona charger (corona discharger) in which a plurality of wires of the charging wire are provided and thus a charging performance is improved has been devised. However, even in the case where such a plurality of wires of the charging wire are provided, when the corona charger is continuously used for a long time, with the result that the charging wire is deteriorated by the electric discharge and thus the charging non-uniformity occurs. Further, current leakage is liable to occur due to deposition of a contaminant such as the electric discharge product. In addition, in the case where the corona discharger is used as the transfer means or the separating means, there is a possibility of an occurrence of improper transfer or improper separation.

Therefore, in order to prevent the occurrence of such charging non-uniformity, a corona charger provided with a mechanism for feeding a fresh charging wire while performing winding-up of the deteriorated charging wire has been devised (Japanese Laid-Open Patent Application (JP-A) 2004-029504 and JP-A Hei 6-124036). In the case of structures described in JP-A 2004-029504 and JP-A Hei 6-124036, a single charging wire is folded (turned) back and used, thus being regarded as two charging wires. Then, by performing a winding-up operation, the charging performance is enhanced and the charging non-uniformity is less liable to occur.

However, in the case of the structures described in JP-A 2004-029504 and JP-A Hei6-124036, when a winding-up operation is performed, a portion of the charging wire to be folded back is not used and is wound up, thus being efficient. That is, in the case of the structures described in JP-A 2004-029504 and JP-A Hei6-124036, the winding-up operation is performed until a portion of the charging wire located upstream of the fold-back portion with respect to a winding-up direction reaches a position in which the portion is located at a downstream side with respect to the winding-up direction, so that the fold-back portion is collected without being used.

On the other hand, in the case where the winding-up operation is performed so as to use the fold-back portion of the charging wire, correspondingly to the fold-back portion remaining in a movement direction downstream area, the portion used for the electric discharge remains in an upstream area of the fold-back portion. Thus, in an area in which the corona discharge should be effected in a range corresponding to an area in which an image is to be formed on a recording material), there is a possibility that a newly fed portion or a newly portion to be folded back is co-present with the portion subjected to the electric discharge. The newly fed portion or the newly portion to be folded back is different in degree of a deterioration of the charging wire from the portion subjected to the electric discharge. For this reason, after the charging wire is moved, a discharging performance is different between these portions in the area in which the corona discharge should be effected, so that charging non-uniformity occurs.

### SUMMARY OF THE INVENTION

A principal object of the present invention is to provide a corona discharger capable of efficiently using a charging wire with less occurrence of a difference in a discharging performance in an area in which corona discharge should be effected after movement, in a stretching direction, of a sing charging wire which is folded back to be regarded as plural wires.

Anther object of the present invention is to provide an image forming apparatus including the corona discharger.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic structural view of an image forming apparatus according to First Embodiment of the present invention.

FIG. 2 is a schematic plan view showing a primary charger in First Embodiment.

FIG. 3 is a schematic side view showing the primary charger in First Embodiment.

FIG. 4 is an enlarged sectional view of a feeding reel.

FIG. 5 is a schematic plan view showing a structure of another primary charger capable of moving a cleaning member.

FIG. 6 is a schematic plan view showing the structure of another primary charger.

FIG. 7 is a block diagram of a winding-up controller in which a charging wire is wound up by a winding-up reel.

FIG. 8 is a flow chart showing interruption timing of the winding-up control.

FIG. 9 is a schematic view showing a relationship between a maximum sheet passing width and a discharging area.

FIG. 10 is a schematic view for illustrating a length of a first portion of a charging wire.

FIG. 11 is a schematic plan view showing a primary charger in Second Embodiment.

FIG. 12 is a schematic side view showing the primary charger in Second Embodiment.

FIG. 13 is a schematic plan view showing a primary charger in Third Embodiment.

FIG. 14 is a schematic side view showing the primary charger in Third Embodiment.

FIG. 15 is an enlarged view of a fold-back portion in Third Embodiment as seen from the right side in FIG. 14.

### DESCRIPTION OF THE PREFERRED EMBODIMENTS

### First Embodiment

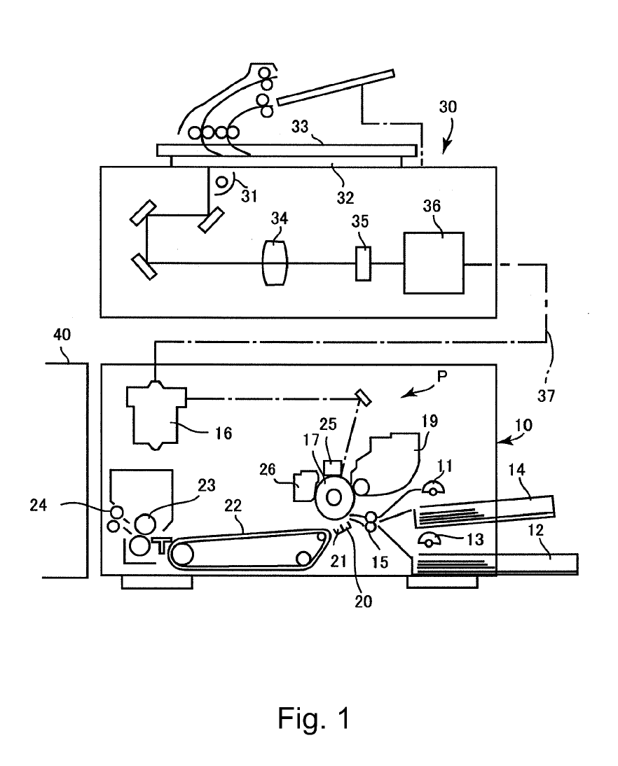

First Embodiment of the present invention will be described with reference to FIGS. 1 to 10. First, a general structure of an image forming apparatus to which the present invention is applied will be described with reference to FIG. 1.

### [Image Forming Apparatus]

As shown in FIG. 1, an image forming apparatus 10 includes an upper cassette 14 and lower cassette 12 for stacking sheets of a recording material on which an image is to be formed. The sheets in the upper cassette 14 are separated one by one by a separation claw (not shown) and a sheet feeding roller 11 to be fed to a registration roller 15. The sheets in the lower cassette 12 are separated one by one by a separation claw (not shown) and a sheet feeding roller 13 to be fed to the registration roller. Then, on the surface of the recording material fed to the registration roller, an image is formed by an image forming portion P.

The image forming portion P is constituted by a photosensitive drum 17, a primary charger 25, a laser scanner 16, a developing device 19, a transfer charger 20, a separation charger 21 and a cleaning 26. The photosensitive drum 17 as an image bearing member is formed in a cylindrical shape and is rotationally driven. By the rotation, a toner image carrying surface is moved. The primary charger 25 as a charging means is constituted by a corona discharger (corona discharge device) disposed opposed to an outer peripheral surface of the photosensitive drum 17 and electrically charges the surface of the photosensitive drum 17 to a predetermined potential by corona discharge.

The laser scanner 16 as an exposure means (electrostatic latent image forming means) irradiates the surface of the photosensitive drum 17 charged by the primary charger 25 with laser modulated on the basis of an electric signal 37 (image data) described later, so that an electrostatic latent image is formed on the surface of the photosensitive drum 17. The developing device 19 as a developing means is disposed opposed to the surface of the photosensitive drum 17 to develop with a toner the electrostatic latent image formed on the surface of the photosensitive drum 17 into a toner image. The toner image carried on the photosensitive drum 17 is transferred at a transfer portion onto the recording material which is conveyed while being timed by the registration roller 15. At the transfer portion, the transfer charger 20 constituted by the corona discharger is disposed opposed to the photosensitive drum 17. By applying a predetermined transfer bias to the transfer charger 20, the toner image is transferred onto the recording material.

The recording material on which the toner image is transferred is separated from the photosensitive drum 17 by applying a predetermined separation bias to the separation charger constituted by the corona discharger, so that the recording material is conveyed to a fixing device 23 by a conveyer belt 22. The toner image is heat-fixed on the recording material by the fixing device 23. Thereafter, the recording material on which the toner image is fixed is discharged on a sorter 40.

Further, in FIG. 1, a scanner 30 as an original reading means includes a scanning optical system light source 31, a platen glass 32, an openable original pressing plate 33, a lens 34, a light-receiving element 35 as a photoelectric conversion element, and an image processing portion 36. An original image read by the scanning optical system light source 31 is processed by the image processing portion 36 and is converted into an electric signal 37 indicated by a chain line and then is set to the laser scanner 16 of the image forming portion P.

### [Corona Discharger]

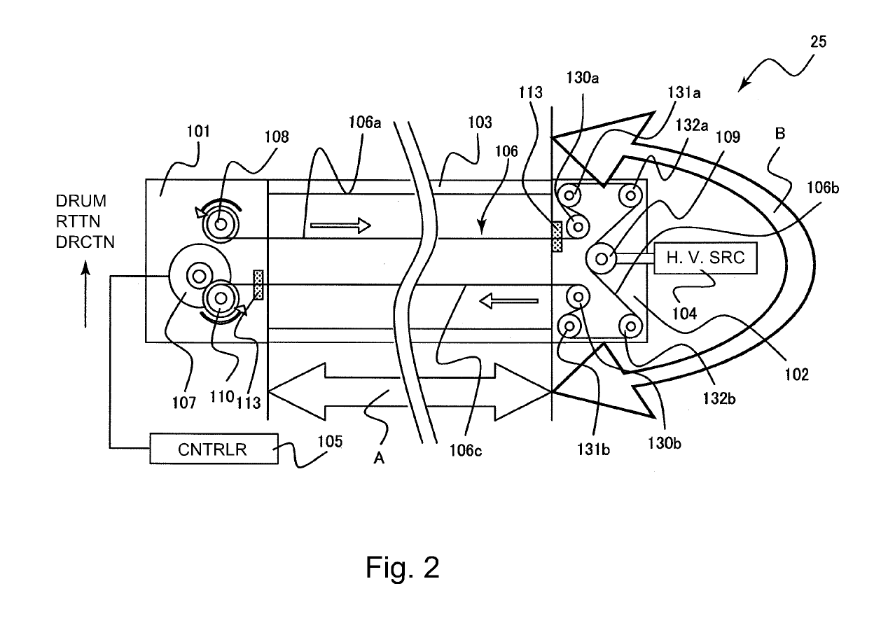

Next, the primary charger 25 as the corona discharger will be described more specifically with reference to FIGS. 2 to 6. The primary charger 25 is the corona charger of a non-contact type in which a grounded shield 103 and a charging wire (charge wire) 106 prepared by subjecting a tungsten wire to gold plating are provided. Then, corona discharge is generated by applying a high voltage to the charging wire 106, so that the surface of the photosensitive drum 17 is charged.

The charging wire 106 is stretched so as to be folded (turned) back at least one position. In this embodiment, the charging wire 106 is folded back at one position as shown in FIG. 2, so that two wires (wire portions) 106a and 106c are stretched (disposed) in the shield 103. The wires 106a and 106c are provided in substantially parallel to a rotational axis direction (perpendicular to a surface movement direction) of the photosensitive drum 17 and are arranged side by side in a rotational direction of the photosensitive drum 17. The primary charger 25 is disposed so that the wire 106c is located at a downstream side and the wire 106b is located at an upstream side, with respect to the rotational direction of the photosensitive drum 17. In an electrode-side case 102 described later and located outside the shield 103, a wire 102b which is a fold-back portion of the charging wire 103 is stretched is provided.

Further, the shield 103 is formed to cover both sides of the wires 106a and 106c with respect to the photosensitive drum rotational direction and to cover a side opposite from the photosensitive drum 17 side. Further, an area which is surrounded by the shield 103 and opposes the photosensitive drum 17 is a discharge (discharging) area A in which the corona discharge is generated. On the other hand, an area outside the shield 103 is a non-discharge area B. The inside of the electrode-side case 102 is the non-discharge area B and the wire 106b disposed in the non-discharge area B is a first portion. The two wires 106a and 106c disposed in the discharge area A are two second portions.

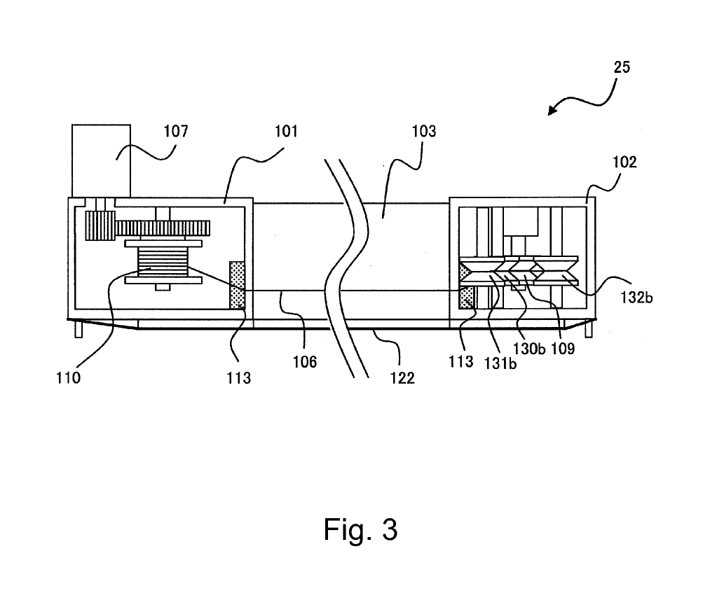

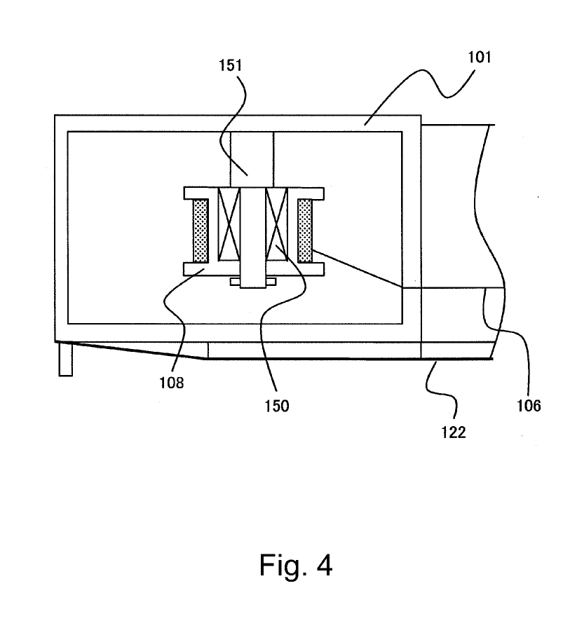

Further, in this embodiment, the primary charger 25 is a charger of a scorotron type. That is, as shown in FIGS. 3 and 4, at a side closer to the photosensitive drum 17 than the charging wire 106, a plurality of grid wires 122 are provided in parallel to the wires 106a and 106b. Therefore, a charge potential of the surface of the photosensitive drum can be variably changed by a voltage applied to the grid wires 122.

Further, as shown in FIGS. 2 and 3, at both sides of the shield in which the wires 106a and 106c are stretched, a drive-side case 101 and an electrode-side case 102 are provided. In the drive-side case 101 provided at one end of the shield 103, a feeding reel 108 as a feeding means, a winding-up reel 110 as a winding-up means and a cleaning member 113 are provided. On the other hand, in the electrode-side core 102 provided at the other end of the shield 103, intermediate reels 130a, 130b, 131a, 131b, 132a and 132b, an electrode reel 109, and a cleaning member 113 are provided. Further, the drive-side case 101 is fixedly provided with a winding-up motor for rotationally driving the winding-up reel 110.

The winding-up reel 110 in the driving-side case 101 is, as shown in FIGS. 2 and 3, rotated by transmitting a driving force from the winding-up motor 107 thereto, thus effecting winding-up of the charging wire 106. Incidentally, although omitted from illustration, the winding-up reel 110 is movable in a rotational axis direction when it winds up the charging wire 106. Further, the charging wire 106 wound up about the winding-up reel 110 is successively arranged along a shaft direction of the winding-up reel 110. As a result, the charging wire 106 is prevented from being concentratedly wound up at one position with respect to the reel shaft direction.

Further, about the feeding reel 108, the charging wire 106 is wound plural times and is fed successively by the feeding reel 108 depending on a winding-up amount of the winding-up reel 110.

As shown in FIG. 4, in the feeding reel 108, a torque limiter 150 is incorporated and applies a predetermined tension to the charging wire 106 when the charging wire 106 is wound up by the winding-up reel 108, thus preventing the charging wire 106 from loosening. Incidentally, as the torque limiter, it is possible to employ a general constitution such as a constitution using a brake, a constitution in which a winding-up shaft 151 and the feeding reel 108 provide a transition fit to obtain a sliding resistance, or the like constitution.

Further, as shown in FIGS. 2 and 3, in the electrode-side case 102, the plurality of the intermediate reels are disposed so that the wire (portion) 106b with a predetermined winding-up described later is stretched by extending the charging wire 106 along these intermediate reels. Further, between the intermediate reels 132a and 132b, the electrode reel 109 connected to a high-voltage source 104 is disposed and about which the charging wire is extended and wound. Further, a high voltage can be applied from the high-voltage source 104 to the charging wire 106.

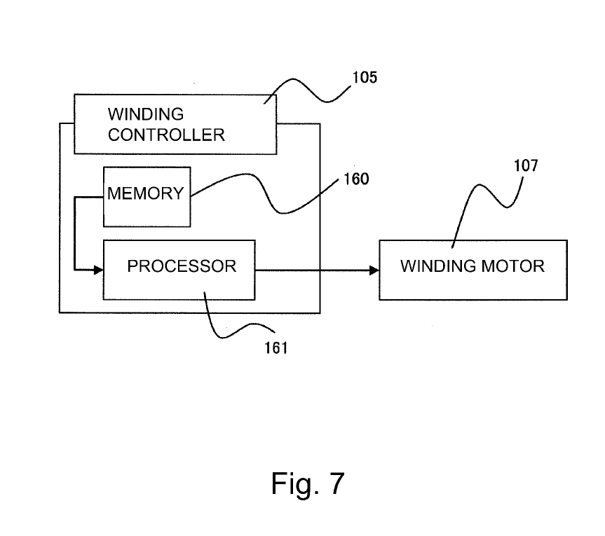

In this embodiment, a moving means for moving the charging wire 106 is constituted by the feeding reel 108, the winding-up reel 110, the driving motor 107 and the winding-up controller 105 (described later with reference to FIG. 7). That is, the charging wire 106 is wound up by driving the driving motor 107 to rotate the winding-up reel 110. Further, depending on a degree of the winding-up, the charging wire 106 is fed from the feeding reel 108. As a result, the charging wire 106 is moved in a direction indicated by arrows in Figure, via the respective intermediate reels and the electrode reel 109.

The cleaning member 113 is provided in each of the driving-side case 101 and the electrode-side case 102. The cleaning member 113 in the driving-side case 101 is disposed upstream of the winding-up reel 110 with respect to a (wire) movement direction of the charging wire 106. The cleaning member 113 in the electrode-side case 102 is disposed upstream of the intermediate reel 130a with respect to the wire movement direction. These cleaning members 113 slide with the charging wire 106 when the charging wire 106 is wound up and moved by the winding-up reel, thus removing a contaminant such as a discharge product deposited on the charging wire 106. Particularly, the cleaning member 113 provided in the electrode-side case 102 cleans the wire 106a stretched in the discharging area A. The wire 106a is then used as the wire 106c and therefore is cleaned by the cleaning member in such a manner, so that deterioration of the wire due to the electric discharge can be delayed at an initial stage. Further, the cleaning member 113 provided in the driving-side case 101 cleans the wire 106c stretched in the discharging area A. This wire 106c is thereafter wound up and collected by the winding-up reel 110. By cleaning the wire 106c, improper winding-up and an winding-up error can be reduced. Incidentally, as described later, the winding-up reel 110 is rotated in a predetermined amount by controlling the driving motor 107 to wind up the charging wire 106 in a predetermined amount but due to a contaminant deposited on the wire 106a, there is a possibility that the winding-up amount per rotation number of the reel is somewhat fluctuated. Further, there is a possibility of an occurrence of the winding-up error due to accumulation of this fluctuation. In this embodiment, the cleaning member 113 is also provided in the driving-side case 101 and therefore such a winding-up error can be reduced. However, the cleaning member 113 provided in the driving-side case 101 can also be omitted.

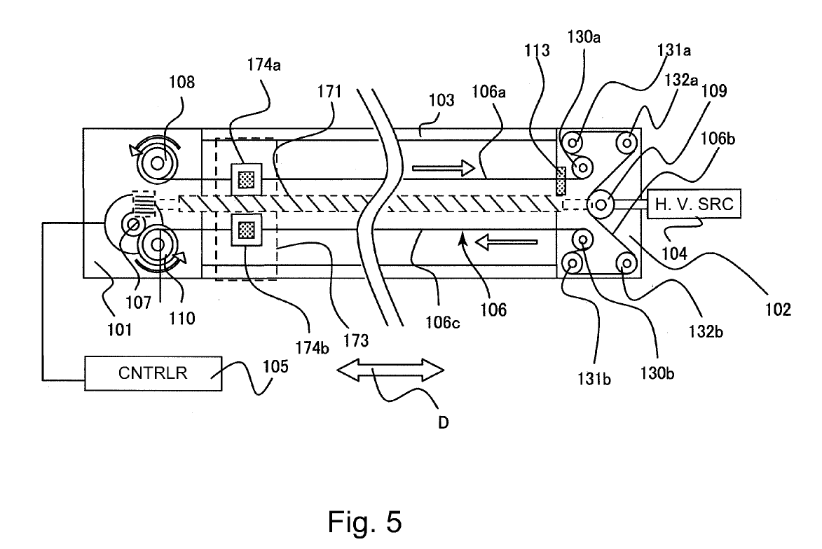

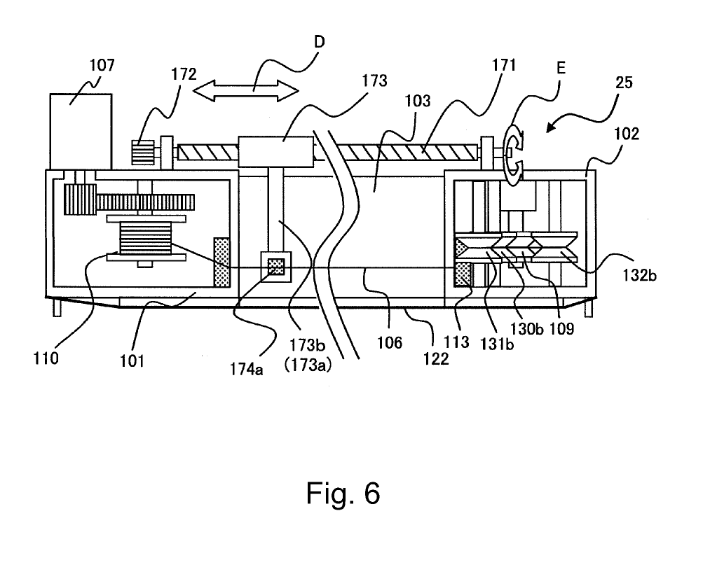

Further, the cleaning member 113 for cleaning the charging wire 106 may also have a constitution as shown in FIGS. 5 and 6. That is, cleaning members 174a and 174b may be moved to clean the wire 106. The constitution shown in FIGS. 5 and 6 will be described below. A screw 171 is held between the driving-side case 101 and the electrode-side case 102 in parallel to the wires 106a and 106b. Further, the screw 171 obtains the driving force from an unshown driving source, capable of being rotated forward and reversely, via a screw gear 172 to rotate forward and reversely (in an arrow E direction). Further, with the screw 171, a cleaning member holding member 171 is engaged and thus is operable in an arrow YD direction along a screw groove of the screw 171. Further, the cleaning member holding member 173 includes arm portions 173a and 173b to which the cleaning members 174a and 174b are mounted, respectively. For that reason, by the forward and reverse rotation of the unshown driving source, the cleaning members 174a and 174b are moved in the arrow D direction, so that the wires 106a and 106b can be cleaned.

As described above, the moving means for moving the charging wire 106 includes the winding-up controller 105 for controlling the drive of the winding-up motor 107. The winding-up controller 105 includes a memory 160 and a processor 161 as shown in FIG. 7. The memory 160 cumulatively adds (counts) and stores the print number. Timing of rotational drive of the winding-up motor 107 is controlled by computing a value, stored in the memory 160, by the processor 161. Incidentally, by an unshown rotation detecting sensor, a rotation angle and the rotation number of the rotation shaft of the winding-up motor 107 are detected and on the basis of its detection result, the winding-up controller 105 controls the winding-up motor 107.

The winding-up controller 105 controls the winding-up motor 107 to move the charging wire 106 in the following manner. That is, the wire fed from the feeding reel 108 is moved to a photosensitive drum rotational direction downstream position in the discharging area A. The wire 106a stretched at the photosensitive drum rotational direction downstream position in the discharging area A is moved into the electrode-side case 102. The wire 106b extended and stretched by the respective intermediate reels and the electrode reel 109 in the electrode-side case 102 is moved to a photosensitive drum rotational direction upstream position in the discharging area A. The wire 106c stretched at the photosensitive drum rotational direction upstream position in the discharging area A is wound up by the winding-up reel 110 provided in the driving-side case 101.

By employing such a constitution, when the surface of the photosensitive drum 17 is charged, a single charging wire 106 can be used as two wires (wire portions) consisting of the wire 106a located at the photosensitive drum rotational direction upstream position and the wire 106c located at the photosensitive drum rotational direction downstream position. As a result, a charging performance is improved and thus charging non-uniformity is less liable to occur. Incidentally, the charging of the surface of the photosensitive drum is effected in the discharging area A (via the wires 106a and 106c) and is not effected in the non-discharge area B in the electrode-side case 102 and in the driving-side case 101.

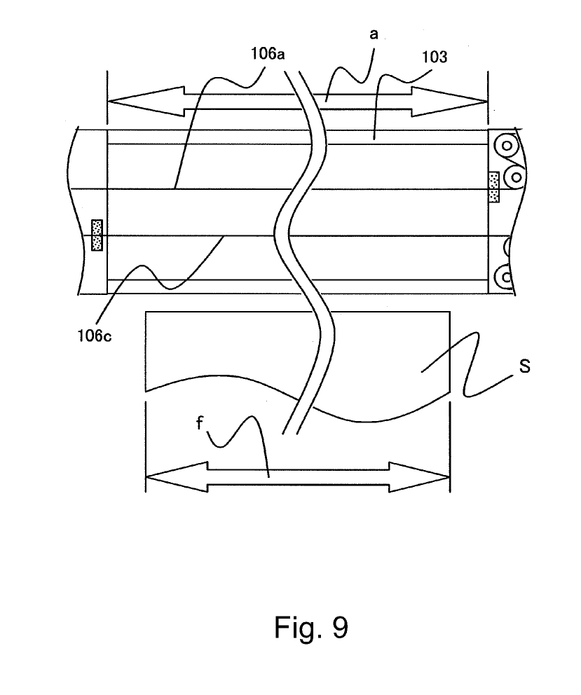

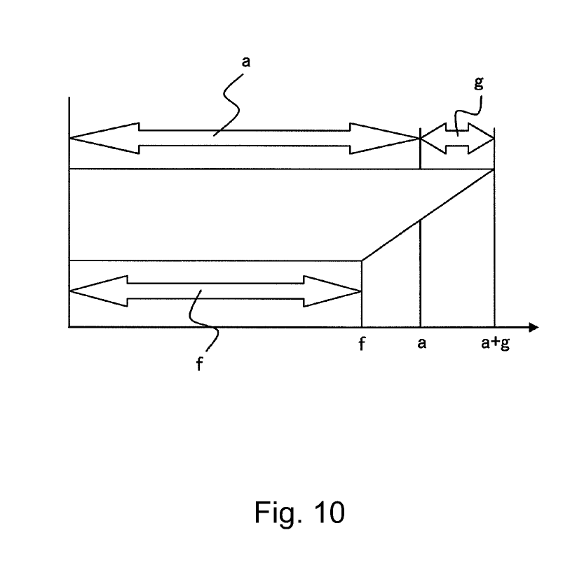

In this embodiment, in order to move the charging wire 106 as described above, the length of the wire 106b as the first portion which is the fold-back portion of the charging wire 106 is determined in the following manner (FIGS. 9 and 10). That is, a length e of the first portion (the wire 106b) is not more than the sum of a length a of one of the two second portions (the wires 106a and 106c) and a movement error g of the charging wire 106 by the moving means, and is not less than a length f of an area in which the corona discharge should be effected. In other words, the following relationship is satisfied.

f≦e≦a+g

Here, the length a of one of the two second portions is equal to a length of each of the wires 106a and 106c in the discharging area A with respect to the stretching direction of the charging wire 106. Further, the movement error of the charging wire 106 is based on product accuracy of constituent members which constitute the moving means and based on a tension or the like of the charging wire 106, and is, e.g., a value of ±g mm with respect to a desire movement amount. Therefore, the movement amount of the charging wire 106 is a value (a+g) as the sum of the second portion length a and the movement error g at the maximum. Incidentally, in the case where the movement error g is slight or the like, the length e of the wire 106b may also be not more than the length a of the wire 106a or the wire 106c without taking the movement error g into consideration.

Further, the area in which the corona discharge should be effected corresponds to an area (image forming area) in which the image is formed on the recording material S. This is because sin this area, the corona discharge is effected to charge the surface of the photosensitive drum 17 in order to form the image. In this embodiment, the area corresponds to a maximum sheet passing width. That is, the length f is the length of the recording material S with a maximum size, for permitting formation of the image by the image forming apparatus, with respect to a widthwise direction of the recording material S (a direction perpendicular to a recording material conveyance direction; a main scan direction).

The reason why the length of the first portion is determined in the above-described manner is as follows. That is, the length (width) a of the discharging area A is equal to or more than the maximum sheet passing width f. As a result, in the whole areas of all of sheet-passable recording materials, it is possible to effect printing (image formation). Incidentally, there are some copying machines by which printing at an end portion of the recording material is not assumed. In this case, the length of the wire 106c may also be determined based on the image forming area (not shown) which is an area in which the toner is placed. For example, there is the case where the values of f and a are equal to each other. In this embodiment, the maximum sheet passing width f is a minimum and therefore the length of the wire 106 is not less than the image forming area.

Specifically, e.g., the length a of the discharging area A is 340 mm. The movement error g is 1 mm, and the maximum sheet passing width f is 330.2 mm. In this case, the length e of the wire 106b is 330.2 mm or more and 341 mm or less.

In this embodiment, the respective intermediate reels and the electrode reel 109 are disposed so that the length e of the wire 106b is within the above range. Then, the driving (winding-up) motor 107 is driven by the winding-up controller 105, so that the charging wire 106 is moved in the following manner. That is, the first portion (the wire 106b) is moved to locate in at least the area, in which the corona discharge should be effected (the area corresponding to the maximum sheet passing width), of the second portion (where the wire 106c is stretched) located downstream of the first portion with respect to the charging wire movement direction. Specifically, the wire 106b may only be required to be moved in the range of f indicated in FIG. 9.

### [Charging Wire Winding-Up Operation]

The operation of the charging wire 106 during exchange will be described. As described above, by rotating the winding-up motor 107 in a predetermined amount, the winding-up reel 110 is rotated in the winding-up direction as shown in FIG. 2, so that the charging wire 106 is wound up about the winding-up reel 110. Further, the feeding reel 108 is rotated by the tension of the charging wire 106 to feed a fresh charging wire 106.

By effecting such rotational control of the winding-up motor 107 in the following manner by the winding-up controller 105 during the deterioration due to the electric discharge of the charging wire 106 for a long time, an exchange process of the charging wire is performed.

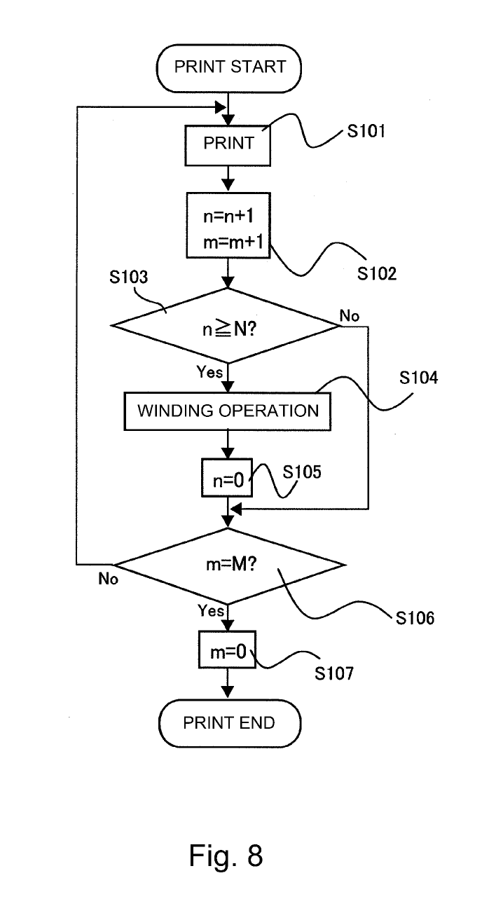

The winding-up control is effected in an interruption manner during the print job. However, in order to reduce a printing time, the winding-up control may also be effected after the job without being effected during the job. In this embodiment, with reference to FIG. 8, the case where the winding-up control of the wire is effected by interrupting the printing job will be described. When the printing operation is started by the image forming apparatus 10, the print image number, i.e., the print number n of sheets is cumulatively added (counted) and stored in a memory 160 (FIG. 7) of the winding-up controller 105 (S102). In S103, when the processing portion 161 (FIG. 7) judges that the print number reaches a predetermined value (the print number N in which the winding-up operation is performed), the operation enters a charging wire exchanging mode. In the operation in the exchanging mode, by rotating the winding-up motor 107, a portion (second portion) of the charging wire 106 used as the photosensitive drum rotational direction upstream wire 106c is wound up by the winding-up reel 110 (S104). At this time, simultaneously, a portion of the charging wire 106 used as the photosensitive drum rotational direction downstream wire 106a is moved to the position of the wire 106b (first portion in the electrode-side case 102). Further, the wire 106b is disposed at the position of the wire 106c (the discharging area A). Further, by feeding a fresh portion of the charging wire 106 by the feeding reel 108, the fresh portion of the charging wire 106 is disposed at the portion (the discharging area A) used as the wire 106a.

As described above, the wire 106b is set, as shown in FIG. 10, so that its length is not more than the sum (a+g) of the length a of the discharging area A and the winding-up error g of the wire during the winding-up operation and is not less than the maximum sheet passing width f of the usable recording material in the image forming apparatus 10. For this reason, the wire 106b disposed in the non-discharge area is moved to the discharging area A, so that the portion used already as the wire 106c is wound up and thus the wire 106c which is used and on which the contaminant is deposited does not remain in the area in which the corona discharge should be effected (particularly in the image forming area). As a result, a good charging performance is obtained.

After the winding-up operation is ended, in S105, the value n in the memory 160 is reset and the printing is continued until the job sheet number m reaches M (the print number per (one) job). At the time of the end of the job, the memory 160 resets the job sheet number m to zero (S107) but still stores the cumulative print number n after the resetting. Then, at the time of a subsequent job, accumulative adding is resumed from the stored value.

According to this embodiment, by performing the wire exchange process as described above, the wire 106b remaining in the non-discharge area B can also be used for charging the surface of the photosensitive drum 17, thus being very economical. There is no co-presence of the first portion and the second portion in the area in which the corona discharge should be effected, so that the difference in charging performance is less liable to occur in the area. That is, the portion present in the discharging area A before the movement of the charging wire 106 and the portion present in the non-discharge area B before the movement of the charging wire 106 are not co-present after the movement of the charging wire 106. At the portion present in the discharging area A, the wire is deteriorated by deposition or the like of the contaminant such as the electric discharge product, so that the charging performance is lowered. On the other hand, at the portion present in the non-discharge area B, the amount of the lowering in charging performance is small (or substantially zero). For this reason, when these portions are co-present, the wires different in charging performance are co-present in the area in which the corona discharge should be effected, so that a difference in discharging performance occurs in the area. When the discharging performance difference occurs, charging non-uniformity occurs and as a result, adversely affects the image formation. In this embodiment, such a situation does not arise.

Further, in this embodiment, a fresh charging wire 106 is supplied to the photosensitive drum rotational direction downstream position in which the charging performance of the wire 106a is largely influenced. On the other hand, the wire 106b which is already used as this wire 106a is to be used as the wire 106a located at the photosensitive drum rotational direction upstream direction in which a degree of the influence on the charging performance is smaller than that at the photosensitive drum rotational direction downstream position. For this reason, the charging performance can be maintained at a good level. That is, at the photosensitive drum rotational direction upstream position, even when somewhat non-uniformity of the wire charging performance arises, the degree of this non-uniformity can be reduced by the wire electric discharge at the photosensitive drum rotational direction downstream position. On the other hand, when the wire charging performance at the rotational direction downstream position is non-uniform, the non-uniformity undesirably remains. In this embodiment, the newly supplied wire is disposed at the rotational direction downstream position, so that the charging non-uniformity can be reduced even when the charging non-uniformity occurs at the upstream position. Thus, a good charging performance of the primary charger can be maintained.

Further, the portion used as the wire 106a is re-used as the wire 106c, so that compared with the case where all the portions of the charging wire 106 are exchanged at a time, such an effect of suppressing a density fluctuation between before and after the exchange is obtained. That is, in the case where all the portions of the charging wire 106 are exchanged at a time, the lowered charging performance is abruptly improved, so that there arises a large difference in charging performance between before and after the exchange. For example, the charging non-uniformity which has arisen is completely eliminated. As a result, the density fluctuation due to the difference in charging performance is caused. On the other hand, in this embodiment, although the wire 106c is the portion cleaned by the cleaning member 113, the contamination on the wire 106a is not completely removed, so that the wire 106c is in a deteriorated state compared with a fresh state. Therefore, a degree of a change in wire deterioration state between before and after the wire exchanging operation can be made smaller than that in the case where the charging wire 106 is completely exchanged to a fresh charging wire, so that the density fluctuation can be suppressed.

Further, in this embodiment, by properly disposing the plurality of the intermediate reels in the electrode-side case 102, the wire 106b having the above-described length can be stretched in a limited space. As a result, an increase in size of the corona discharger is suppressed.

Incidentally, the movement direction of the charging wire 106 can be an opposite direction from that described in the above constitution. That is, a constitution in which the photosensitive drum rotational direction downstream wire 106a is wound up and a fresh charging wire 106b is supplied to the photosensitive drum rotation direction upstream position may also be employed.

Incidentally, as a condition of transition to the operation in the exchanging mode, different from the print image number, it is also possible to use an elapsed time in the case where an electric discharging time of the primary charger 25 is cumulatively added and reaches a predetermined time. In addition, the operation may also enter the exchanging mode in the case where a voltage applied to the charging wire 106 is measured and reaches a predetermined value or the case where a potential of the photosensitive drum surface is measured by a surface electrometer and reaches a value not more than a predetermined potential.

### Second Embodiment

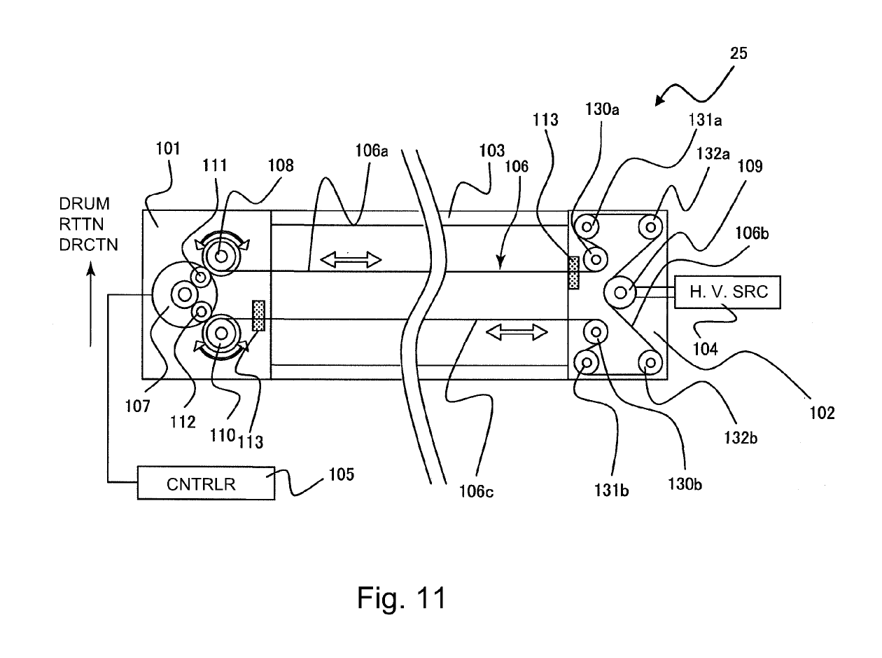

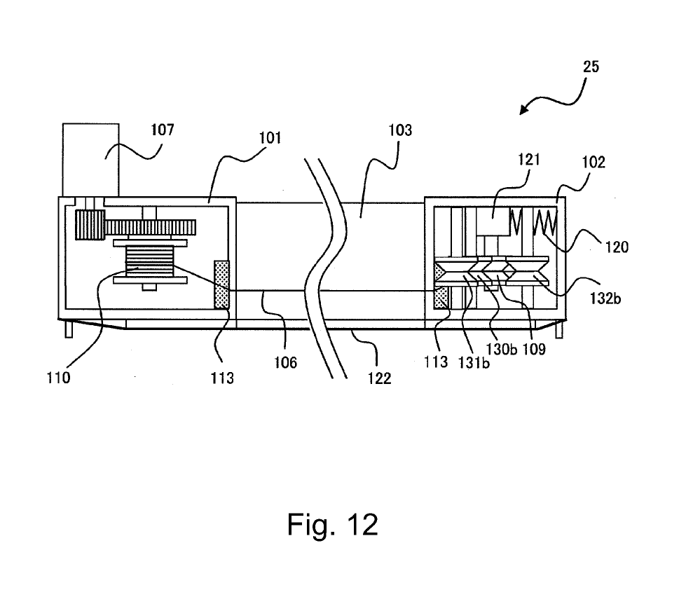

Second Embodiment of the present invention will be described with reference to FIGS. 11 to 12. Hereinbelow, a constitution different from that in First Embodiment will be principally described and description of a constitution similar to that of First Embodiment will be omitted or simplified.

In this embodiment, the moving means for moving the charging wire 106 is capable of moving the charging wire 106 in both directions of the stretching direction of each of the wires 106a and 106c. That is, as shown in FIG. 11, the winding-up motor 107 transmits the driving forces to the feeding reel 108 and the winding-up reel 110 via a feeding gear 111 and a winding-up gear 112, respectively. In this embodiment, in the feeding reel 108, the torque limiter 150 as shown in FIG. 4 is not incorporated.

As shown in FIG. 12, the electrode reel 109 is provided on an electrode base 121 movable in the horizontal direction in the figure. To the electrode base 121, a force is applied in a leftward direction in the figure by an electrode base spring 120. As a result, the charging wire 106 wound about the electrode reel 109 is stretched, so that the charging wire 106 does not slacken among the feeding reel 108, the winding-up reel 110 and the electrode reel 109.

In such a constitution, by reversely rotating the winding-up motor 107, the charging wire 106 once wound up by the winding-up reel 110 can be fed into the discharging area A again. At that time, the charging wire 106 is cleaned by the cleaning member 113 in the driving-side case 101 and then is fed into the discharging area A. In this embodiment, similarly as in First Embodiment, the exchanging operation of the charging wire 106 is performed, so that lifetime extension of the charging wire 106 can be realized.

### Third Embodiment

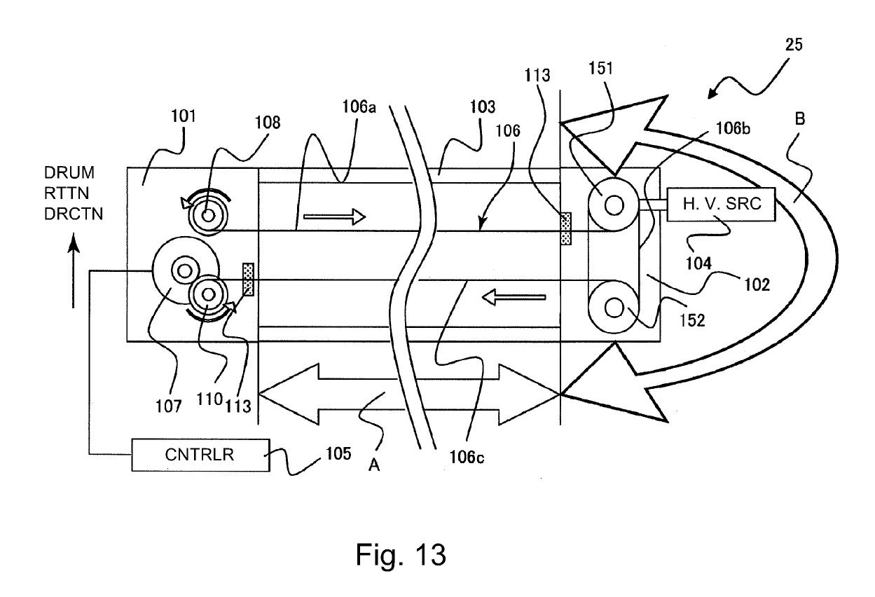

Third Embodiment of the present invention will be described with reference to FIGS. 13 to 15. Hereinbelow, a constitution different from that in First and Second Embodiments will be principally described and description of a constitution similar to those of First and Second Embodiments will be omitted or simplified.

In this embodiment, the fold-back portion, i.e., the reel which is provided in the electrode-side case 102 and to which the wire 106b is extended and wound is configured to have a vertically connected structure, with a plurality of grooves, extending along the rotational axis direction of the reel. That is, the wires can be wound plural times about a single reel. Such a reel is provided in a pair, so that the wire is extended alternately between the pair of reels.

That is, in the electrode-side case 102, vertically connected reels 151 and 152 which are the pair of reels are provided. Each of the vertically connected reels 151 and 152 has a constitution in which a plurality of reel portions are vertically connected (in the rotational axis direction). In other words, a plurality of grooves along which the wire is extended are provided vertically. Incidentally, each of the vertically connected reels 151 and 152 can also be constituted by coaxially disposing a plurality of independent reels in combination.

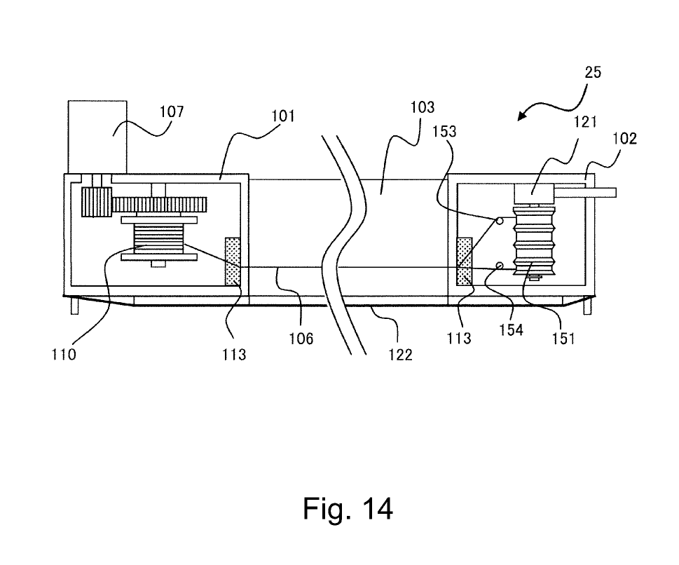

Further, as shown in FIG. 14, an upstream reel guide 153 is stretched upstream of the vertically connected reel 151, with respect to a feeding direction of the charging wire 106, located at the photosensitive drum rotational direction downstream position. The upstream reel guide 153 guides the charging wire 106 fed to the vertically connected reel 151. On the other hand, a downstream reel guide 154 is stretched downstream of the vertically connected reel 152 with respect to the feeding direction of the charging wire 106, located at the photosensitive drum rotational direction upstream position. The downstream reel guide 154 guides the charging wire 106 fed from the vertically connected reel 152 toward the discharging area A.

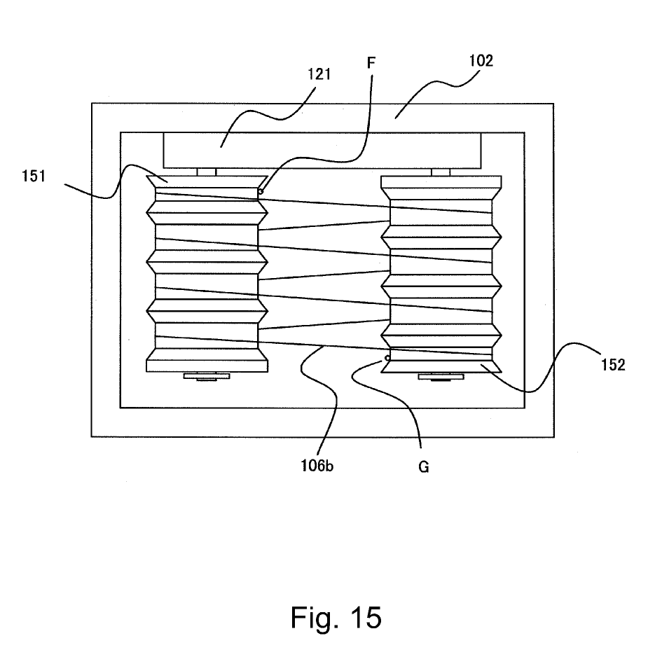

As specifically illustrated in FIG. 15, the charging wire 106 fed in the electrode-side case 102 is guided by the upstream reel guide 153 and then is wound about the vertically connected reel 151 from a position F. Thereafter, the charging wire 106 is wound about the adjacent vertically connected reel 152 and then is reciprocally wound between the vertically connected reels 151 and 152. Finally, the charging wire 106 is stretched from a position G of the vertically connected reel 152 toward the discharging area A via the downstream reel guide 154.

In this embodiment, compared with First and Second Embodiments described above, there is no need to provide the plurality of reels at positions deviated from the coaxial position, thus being economical. Incidentally, in this embodiment, as the driving constitution for moving the charging wire 106, the same constitution as that in First Embodiment is employed but may also be changed to that in Second Embodiment.

### Other Embodiments

In the embodiments described above, the constitution in which the present invention is applied to the primary charger is described but the present invention is also applicable to other corona discharger such as the transfer charger 20 and the separation charger 21. As a result, it is possible to suppress occurrences of the improper transfer and the improper separation. Further, the charging wire 106 may also be folded back at two or more positions, not at one position, so that the present invention is also applicable to a constitution in which three or more second portions are provided. That is, a constitution in which at least one first portion and at least two second portions are provided may be employed. In other words, when a structure in which the single charging wire is folded back to be regarded as a plurality of wires (wire portions) and is moved in the stretching direction is used, the present invention is applicable to the structure. Also in this case, each first portion length is properly regulated. Further, in the above-described embodiments, the case where the present invention is applied to a single color image forming apparatus but is also applicable to an image forming apparatus for forming a plurality of color images, such as a full-color image forming apparatus.

Further, the first portion length can be used, when the first portion length is not less than the length of the area in which the corona discharge should be effected, as the length of the second portion since the degree of the occurrence of the discharging non-uniformity can be reduced. Further, in this case, the first portion length can also be a multiple integral of the length of the area in which the corona discharge should be effected. For example, in the case where the first portion length is two times the length of the area, the first portion has a length corresponding to two times of the wire exchanging operation and thus during the wire exchanging operation, when the wire is moved every length which is ½ of the first portion length, the first portion can be used as the second portion while eliminating waste.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 259017/2010 filed Nov. 19, 2010, which is hereby incorporated by reference.

What is claimed is:

1. A corona discharger, including a shield and a charging wire stretched in the shield, for generating corona discharge by applying a voltage to the charging wire, said corona discharger comprising:
moving means for moving said charging wire along a stretching direction;
stretching means for stretching said charging wire through a first charging area, a non-charging area and a second charging area and for folding said charging wire in the non-charging area back into the second charging area, the first and second charging areas being substantially parallel with each other, and a portion of said charging wire disposed in the non-charging area having a length not less than a length of said charging wire disposed in the second charging area; and
control means for controlling said moving means such that the portion of said charging wire disposed in the non-charging area replaces the portion of said charging wire disposed in the second charging area.

2. A discharger according to claim 1, wherein the length of the portion of the charging wire disposed in the non-charging area is not more than the sum of a length of one of the portions of said charging wire disposed in the first and second charging areas and a movement error of said charging wire by said moving means.

3. A discharger according to claim 1, wherein said moving means includes feeding means for feeding said charging wire, winding-up means for winding-up said charging wire and driving means for driving at least said winding-up means.

4. An image forming apparatus comprising:
an image bearing member for bearing a toner image; and
a discharger according to claim 1 for electrically charging said image bearing member,
wherein said corona discharger is provided opposed to a surface of said image bearing member so that the stretching direction of the portions of the charging wire disposed in the first and second charging areas is parallel to a direction crossing a movement direction of the surface of said image bearing member and so that the portions of said charging wire disposed in the first and second charging areas are located downstream and upstream, respectively, of the portion of the charging wire disposed in the non-charging area with respect to the movement direction of the surface of said image bearing member.
